(19) United States
(12) Patent Application Publication
(10) Pub. No.: US 2022/0061261 A1
(43) Pub. Date: Mar. 3, 2022

(54) KENNEL MAT

(71) Applicant: Dry Dog LLC, Edina, MN (US)

(72) Inventor: Benjamin A. Bohline, Edina, MN (US)

(21) Appl. No.: 17/525,834

(22) Filed: Nov. 12, 2021

Related U.S. Application Data
(63) Continuation-in-part of application No. 29/814,785, filed on Nov. 9, 2021.
Application No. 29/814,785 is a continuation of application No. 15/786,338, filed on Oct. 17, 2017.
Application No. 15/786,338 is a continuation-in-part of application No. 29/599,290, filed on Mar. 31, 2017, now Pat. No. D826480.
(60) Provisional application No. 62/409,146, filed on Oct. 17, 2016.

(51) Int. Cl. A01K 1/015; A01K 1/035

(52) U.S. Cl. CPC A01K 1/0157; A01K 1/03; A01K 1/0353

(57) ABSTRACT

A kennel mat having a semi-rigid base as a floor, a platform, a plurality of raised shapes, walls with protruding sections, cushioned shapes attached to the raised shapes and the protruding sections, and gutters. More specifically, the semi-rigid base/floor, platform, raised shapes, walls, and protruding sections can be formed from a single thermoformed elastomeric part, and the cushioned shapes can be made of closed cell foam. The kennel mat may be approximately rectangular in shape, having two long walls and two short walls, wherein one of the short walls can have an arched cutout. The walls of the kennel mat may be configured to eliminate gaps between themselves and the inner walls of a kennel.

### FIELD OF THE DISCLOSURE

This disclosure relates to a kennel mat for enabling animals to dry quickly. More specifically, it relates to a removable kennel mat for insertion into a kennel, wherein the kennel mat has a semi-rigid base as a floor, a raised platform, and a series of ridges on the raised platform, wherein the raised platform and the series of ridges allow liquid and debris to pass through to the semi-rigid base/floor, and the kennel mat is structured and configured to eliminate gaps between the perimeter of the kennel mat and the inner walls of the kennel.

### BACKGROUND OF THE INVENTION

Dog and animal owners often buy mats or beds for their animals to sit on when locked in a kennel. This provides additional comfort for the animal. However, these mats and beds are made with fabric, are often stuffed with soft material, and are typically not water-resistant. Therefore, they tend to acquire odor and are more subject to damage or destruction, whether by an animal, moisture, or overall environmental exposure. Additionally, these mats usually come in a predetermined size without regard to fit in specific kennel models. A well-fitted, gap eliminating, water-resistant, and durable kennel mat is needed that permits fast drying of dogs or other animals and mat materials.

### SUMMARY OF THE INVENTION

The present disclosure relates to a removable, water-resistant, durable kennel mat having a semi-rigid base as a floor, a platform raised above the floor, and walls that are durable and resistant to chewing, scratching, fading, cracking, and water, and other liquids. Additionally, the platform can include a series of ridges, and the walls can include a plurality of protruding sections. The ridges and protruding sections may also be water-resistant and durable and may have a cushioned material adhered to their top surfaces that has padded qualities, is water-resistant, and can withstand chewing, scratching, fading, and cracking.

In an illustrative but non-limiting example, this disclosure provides a kennel mat having a wall with a top, a bottom, and inner and outer surfaces. The bottom of the wall can connect to a floor of the kennel mat. The wall can surround the floor, and the wall and floor together can be constructed of either one or two pieces of a semi-rigid material. The top of the wall may comprise a plurality of eaves that project outward, wherein the eaves are configured to conform to the interior structure of a kennel to eliminate gaps between the kennel mat and the kennel.

The wall may include a plurality of protruding sections going inward that are below the eaves. The plurality of protruding sections can convexly slope beginning from the top of the wall where they are nearly parallel to the wall and ending further down the wall where a top surface of each projection is nearly parallel to the floor. The slope can be a single radius. At the point where the top surface of each projection is nearly parallel to the floor, a side surface of each projection can become perpendicular to the floor to form a junction to the floor. The junction between the protruding sections and the floor can define a lower perimeter of a lower surface of the floor.

The kennel mat may further include a platform raised above the floor, and the space between the platform and the inward protruding sections and wall defines a gutter. The lower surface of the gutter can define the supports for the kennel mat. Within the surface of the platform can be a series of raised ridges that are parallel and equally spaced apart. Each of the ridges may contain a layer of closed-cell foam on its upper surface.

In further examples, the kennel mat's wall may comprise four sides: a front, a back, a left, and a right. In some embodiments, the front side may not contain any inward protruding sections. Additionally, the protruding sections within the right and left sides may be structured, so their width is at least twice the distance of the space between the protruding sections. Furthermore, the back side protruding sections may be the same width as the right and left side protruding sections and can be centered as a group on the back side. The back side protruding sections may not extend into the plane defined by the raised platform. The backmost protruding sections of the right and left sides may be spaced away from the back side, and the outermost protruding sections on the back side may be spaced away from the right and left sides. In some embodiments, the right and left sides may have at least four protruding sections, and the back side may have at least two protruding sections.

In some examples, the back, left, and right sides may contain eaves projecting outward. Additionally, there may be at least one scalloped area within a back side inward projection. In some cases, the scalloped area may be in two of the back side protruding sections. Further, the scalloped area may indent toward the inner surface of the wall and may be disposed on the area that is at the top of the wall.

In further examples, some kennel mats may include a platform that is congruent in shape to the walls of the kennel mat. This may mimic the internal shape of the kennel for which the kennel mat is structured and configured to fit within. The ridges of the platform may each have a length that is greater than a width, and the ridges may be diagonally angled with respect to the front and back sides of the wall. In some examples, the ridges may be angled between 30 and 60 degrees as measured against the front and back sides. In one particular example, the ridges may comprise an angle of 45 degrees. Additionally, the series of ridges may, in some examples, have a distance between each ridge that can be less than half of the width of each ridge.

In some embodiments, the kennel mat may be constructed of an elastomeric compound. For example, the elastomeric compound may be a thermoplastic elastomer. In some cases, the wall, the plurality of eaves, the plurality of protruding sections, the platform, and the series of ridges of the kennel mat may be formed from a single thermoformed part. In some cases, the outer surface of the wall may include indentations that correspond to the plurality of inward protruding sections. And in some cases, the bottom side of the kennel mat may include indentations that correspond to the platform and the series of ridges.

### BRIEF DESCRIPTION OF THE DRAWINGS

FIG. 1 is a top perspective view of a kennel mat according to one embodiment of the present disclosure.

FIG. 2 is a top perspective view of a kennel mat according to one embodiment of the present disclosure.

FIG. 3 is a top plan view of the kennel mat of FIG. 1.

FIG. 4 is a bottom plan view of the kennel mat of FIG. 1.

FIG. 5 is a top plan view of the kennel mat of FIG. 2.

FIG. 6 is a bottom plan view of the kennel mat of FIG. 2.

FIG. 7 is a back elevational view of a kennel mat according to one embodiment of the present disclosure.

FIG. 8 is a front elevational view of a kennel mat according to one embodiment of the present disclosure.

FIG. 9 is a cross-section view of a kennel mat according to one embodiment of the present disclosure.

FIG. 10 is a right side elevational view of a kennel mat according to one embodiment of the present disclosure; the left side elevational view is a mirror image of the right side elevational view.

FIG. 11 is a top plan view of a kennel mat according to one embodiment of the present disclosure.

FIG. 12 is a bottom plan view of the kennel mat of FIG. 11.

FIG. 13 is a back elevational view of the kennel mat of FIG. 11.

FIG. 14 is a front elevational view of the kennel mat of FIG. 11.

FIG. 15 is a left side elevational view of the kennel mat of FIG. 11.

FIG. 16 is a right side elevational view of the kennel mat of FIG. 11.

FIG. 17 is a cross-sectional front view of the kennel mat of FIG. 11 taken from the line 17-17 in FIG. 11.

FIG. 18 is a top, front right side perspective view of the kennel mat of FIG. 11.

FIG. 19 is a bottom, front left side perspective view of the kennel mat of FIG. 11.

### DETAILED DESCRIPTION

The present disclosure relates to a kennel mat that can be used as a removable insert in a kennel and that can enable a dog or other animal to stay dry, and that permits faster, easier, and more hygienic drying of the animal and mat. Various embodiments of the kennel mat will be described in detail with reference to the drawings, wherein like reference numerals represent like parts and assemblies throughout the several views. Reference to various embodiments does not limit the scope of the kennel mat disclosed herein. Additionally, any examples set forth in this specification are not intended to be limiting and merely set forth some of the many possible embodiments for the kennel mat. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

Some embodiments of the kennel mat disclosed herein include features that facilitate removable insertion of the kennel mat into a kennel for a wet and/or dirty dog. However, the mat may be used for any kennel, regardless of the type of animal being crated. The physical properties of the kennel mat enable the mat to be resistant to scratches, tears, stains, water, and odor, all while allowing the animal to be comfortable while confined in the kennel.

More specifically, the kennel mat, in some embodiments, has a semi-rigid base/floor 102 created from an elastomeric compound, such as, but not limited to, a thermoplastic elastomer (TPE), a platform 104 raised above and, in some cases, configured on top of the semi-rigid base/floor 102, and cushioned shapes 116, such as closed cell foam, attached to the top of the platform 104. The semi-rigid base/floor 102 may comprise the floor of the kennel mat. The kennel mat can have a single formed (such as thermoformed) or constructed part that includes the floor 102 and the platform 104, and the cushioned shapes 116 (such as closed cell foam) can adhere to the platform 104. More specifically, the platform 104 can have a series of ridges 106 such as, but not limited to, discs, linear rows, diagonal rows, or any other pattern or combination of patterns to which the cushioned shapes 116 (such as closed cell foam), having corresponding discs, linear rows, diagonal rows, or other patterns, can adhere. In some embodiments, the platform 104 is a raised body, which, in combination with the walls and floor, defines a gutter 114 that surrounds the perimeter of the platform 104, and the series of ridges 106 lift up off of the raised body. In other embodiments, the platform 104 only has the series of ridges 106, and the platform can be either concave or flat such the floor and the platform are the same height.

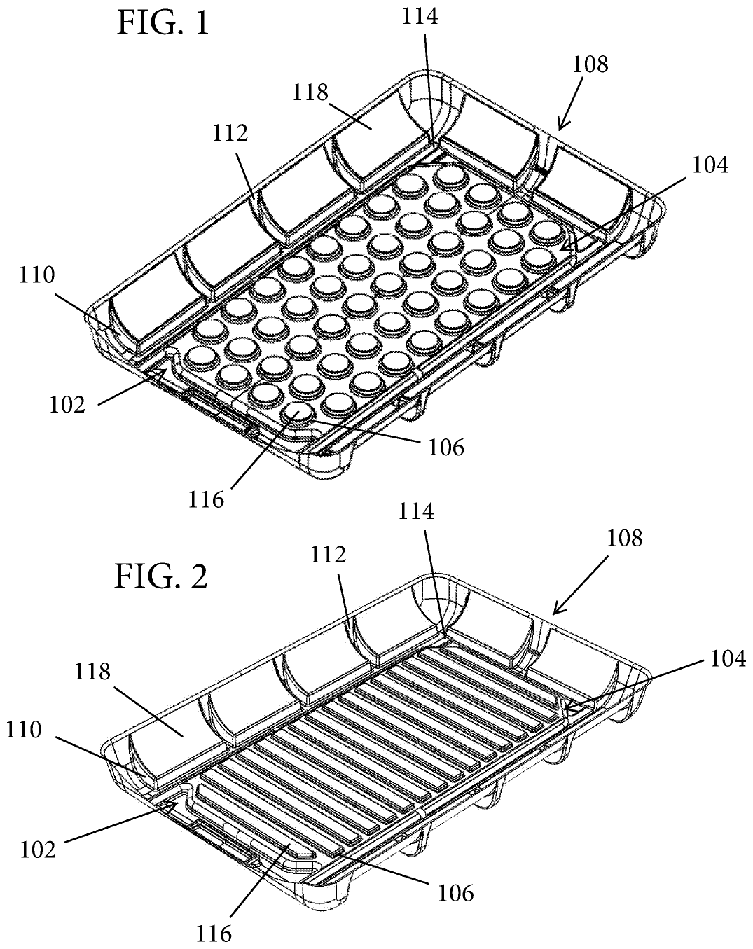

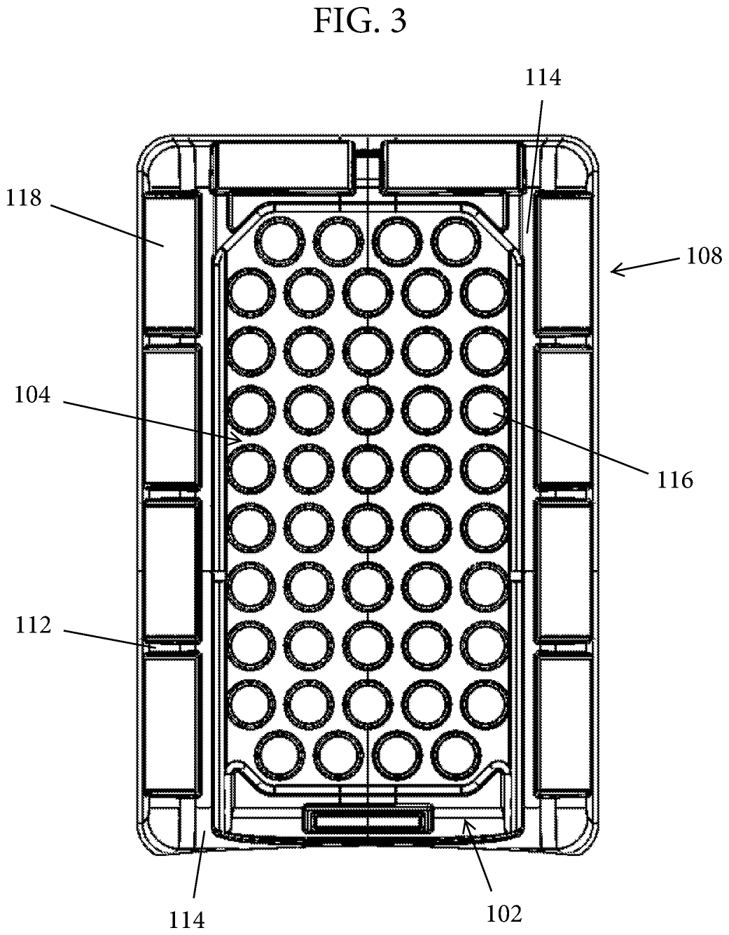

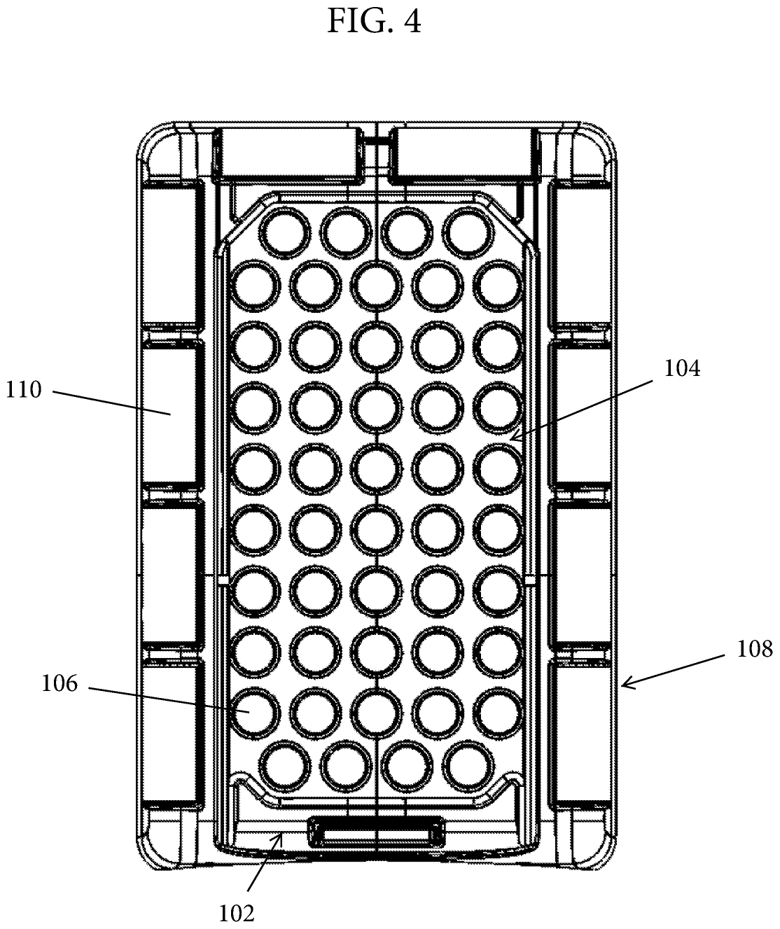

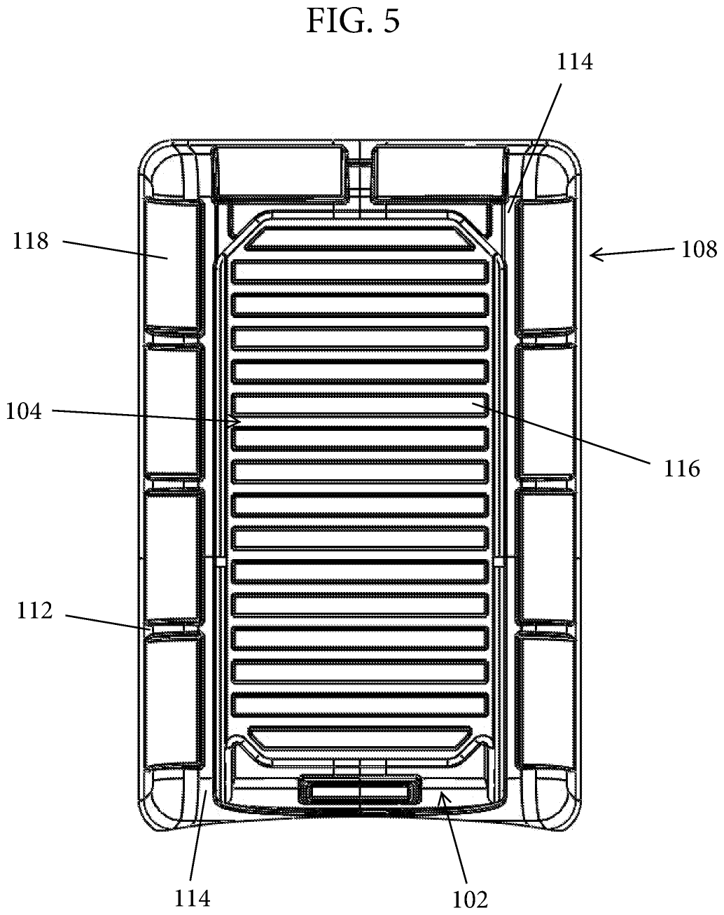

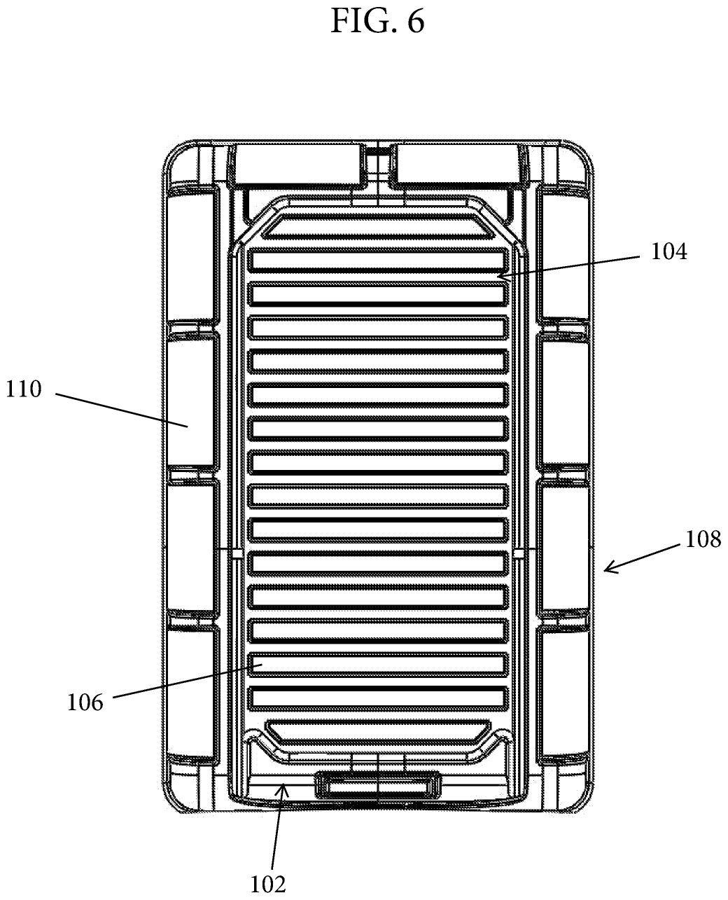

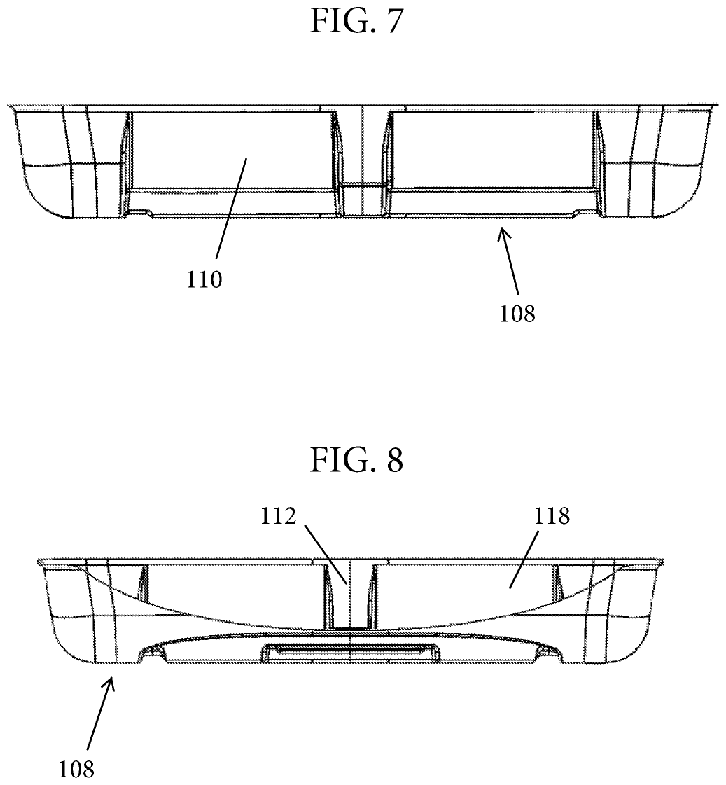

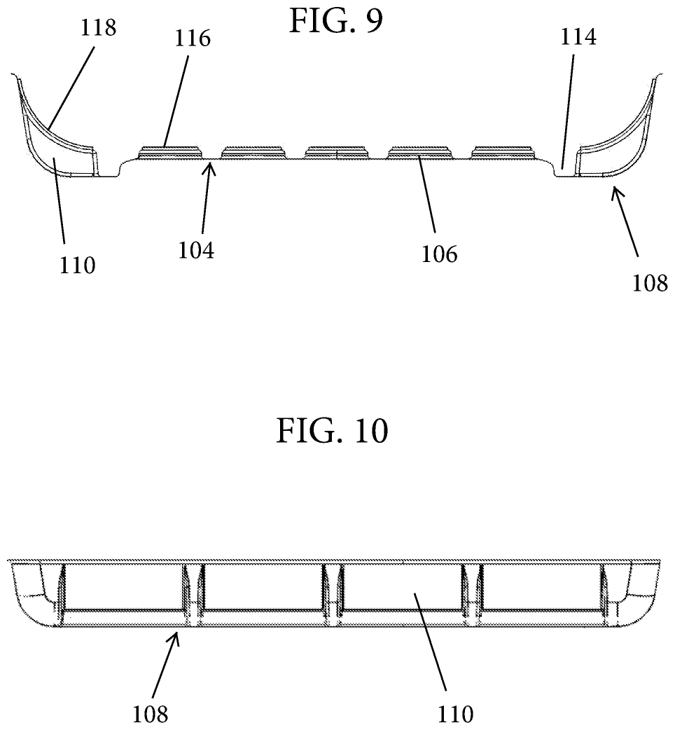

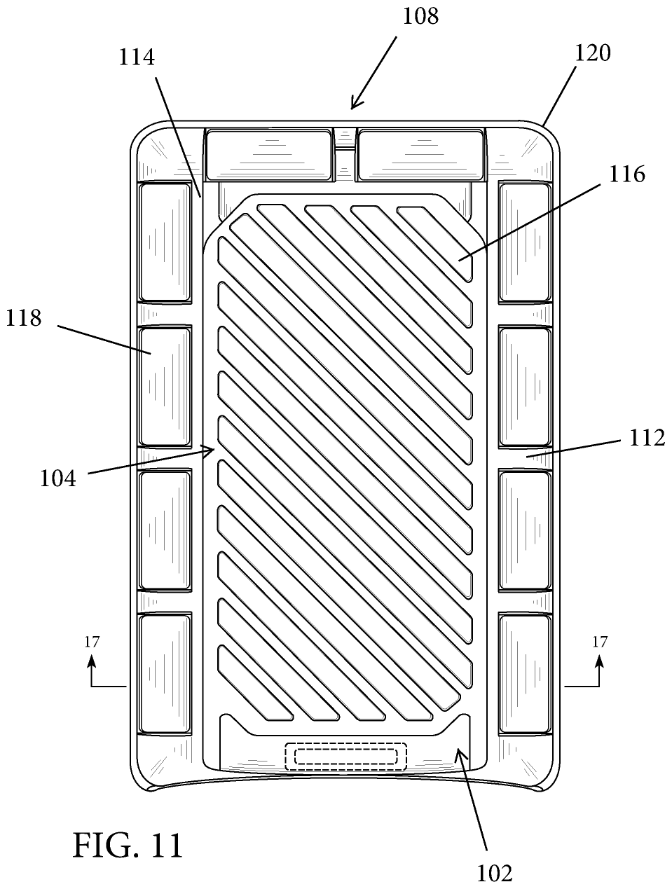

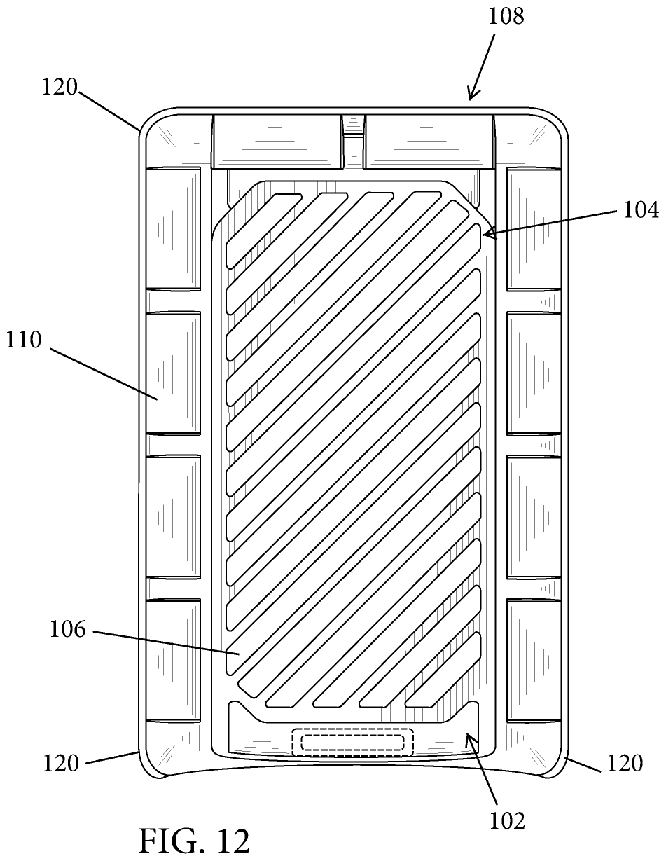

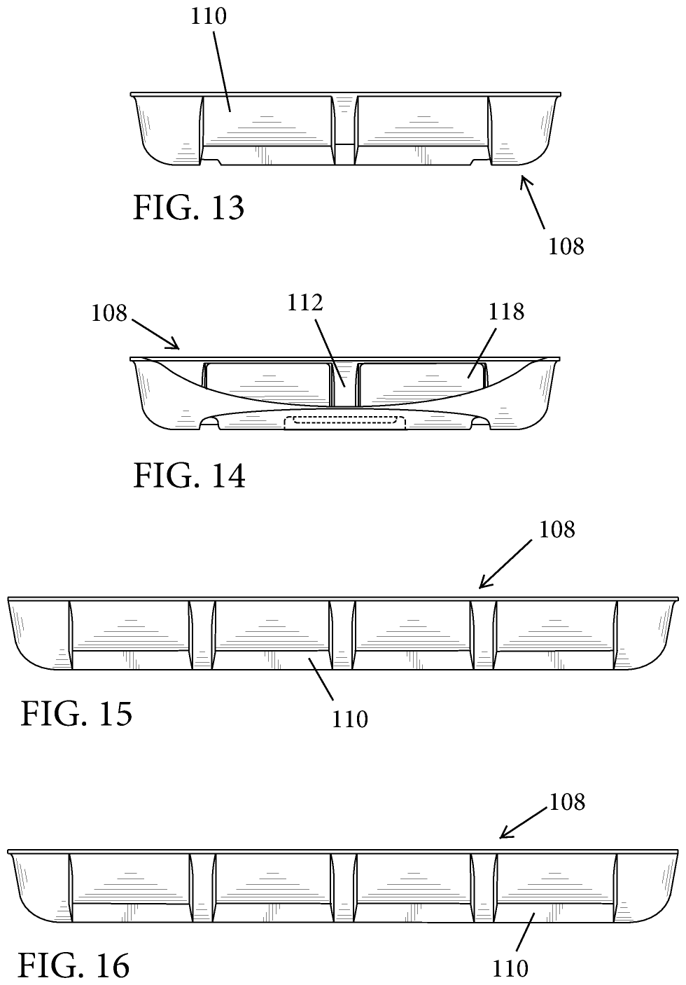

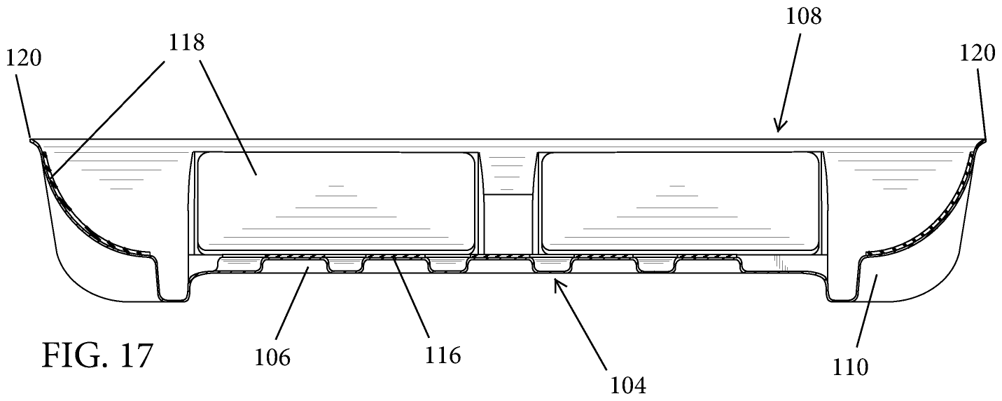

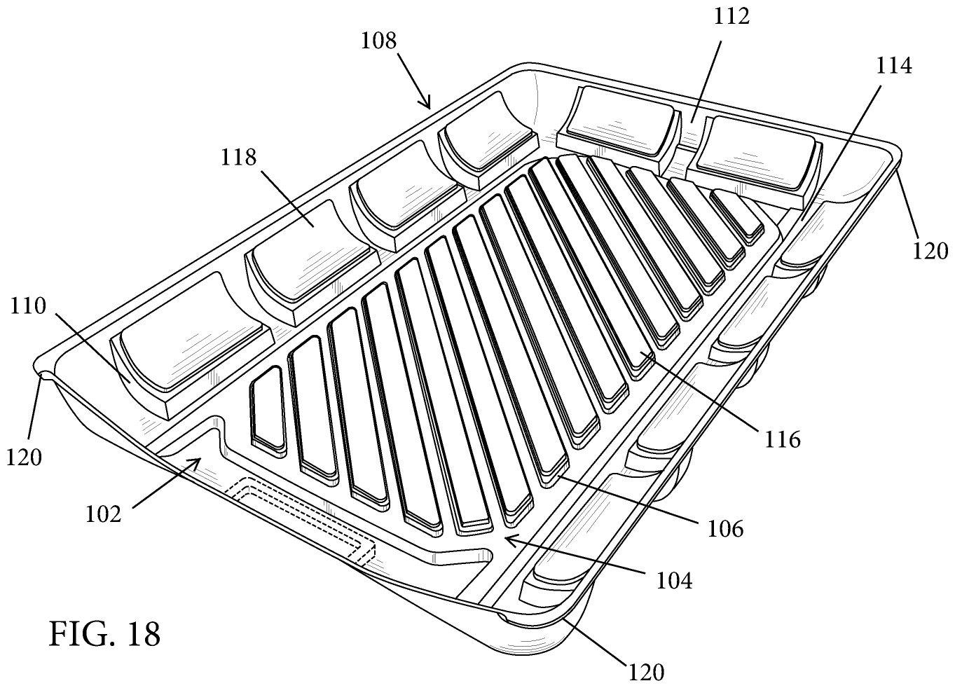

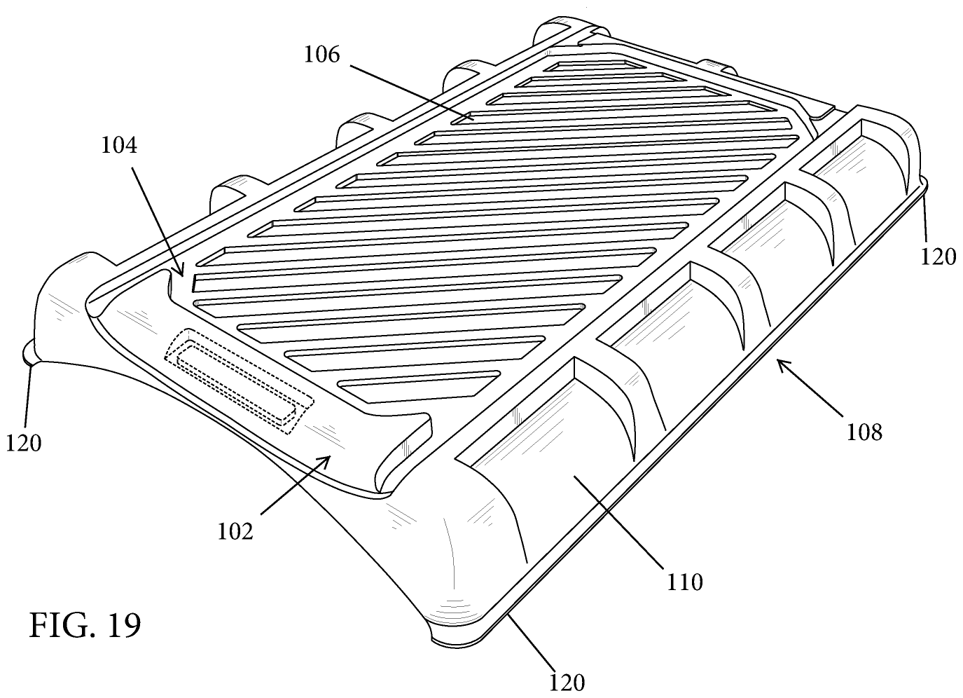

FIGS. 1-19 illustrate various views of example kennel mats according to the present disclosure. FIG. 1 is a top perspective view of a first embodiment. FIG. 2 is a top perspective view of a second embodiment. FIG. 3 is a top plan view of the first embodiment. FIG. 4 is a bottom plan view of the first embodiment. FIG. 5 is a top plan view of the second embodiment. FIG. 6 is a bottom plan view of the second embodiment. FIG. 7 is a back elevational view. FIG. 8 is a front elevational view. FIG. 9 is a cross-sectional view of the first embodiment. FIG. 10 is a right side elevational view. FIG. 11 is a top plan view of a third embodiment. FIG. 12 is a bottom plan view of the third embodiment. FIG. 13 is a back elevational view of the third embodiment. FIG. 14 is a front elevational view of the third embodiment. FIG. 15 is a left side elevational view of the third embodiment. FIG. 16 is a right side elevational view of the third embodiment. FIG. 17 is a front, cross-sectional view of the third embodiment. FIG. 18 is a top perspective view of the third embodiment. FIG. 19 is a bottom perspective view of the third embodiment.

Generally, as illustrated in FIGS. 1, 2, and 18, the kennel mat can be approximately rectangular in nature and has raised walls. However, the kennel mat can take any shape, such as, but not limited to, a square, quadrilateral, trapezoid, or other non-standard shapes; the shape may primarily be defined by the kennel that the mat is structured and configured to fit within. In one embodiment, the kennel mat can be comprised of a semi-rigid base/floor 102, a platform 104 having a series of ridges 106 projecting from the platform and to which corresponding soft, cushioned shapes 116 can attach, walls 108 having protruding sections 110 separated by spaces or gaps 112, and gutters 114 surrounding the circumference of the platform 104 and at the base of the protruding sections 110.

The protruding sections 110 are designed to cushion the animal that rests on the kennel mat and to lift the animal away from any liquids or debris in the gutters 114. The protruding sections 110 can slope convexly downward from the top of the walls 108, where they are nearly parallel to the wall. They can continue further down the wall and end at a point where a top surface of each protruding section 110 is nearly parallel to the platform 104 and the floor 102. The slope of each of the protruding sections 110 may be a single radius until it reaches that nearly parallel point. At that position, a side surface of each protruding section 110 may connect to the floor 102 via a perpendicular connection. Therefore, the bottommost point of the sloping portion of each protruding section 110 can be the uppermost point of the side surface of each corresponding protruding section 110, and the point where the side surface connects to the floor 102 can be the lowermost point of the side surface of each corresponding protruding sections 110. The height of the side surface of the protruding section 110 may be slightly higher than the height of the platform 104. The side surface of the protruding section 110 and the side of the platform 104 may define the exterior and interior circumferences of the gutter 114. FIG. 9 illustrates an embodiment where the protruding sections 110 are slightly higher than the platform 104 and define an exterior circumference of the gutter 114. The gutter 114 may also be further defined by the gaps 112 such that the gutter may include branches that span from the inner surface of the wall to the main channel of the gutter and are located between the protruding sections 110.

As illustrated in FIGS. 18 and 19, the upper rim of the walls 108 may include a plurality of outward projecting eaves 120 that can be configured to conform to the internal wall surfaces of the kennel that the mat is structured and configured to fit within, thereby eliminating gaps between the eaves 120 and the internal wall surfaces of the kennel. More specifically, the eaves 120 may be located on each of the front, right, and left side walls 108 (and in some cases, the front wall as well), and they may project outward past the walls 108 of the kennel mat such that they create an overhang. The eaves 120 may be comprised of an elastomeric compound, for example, a thermoplastic elastomer, and they may be formed from a single thermoformed part along with the wall 108, the protruding sections 110, the floor 102, the platform 104, and the series of ridges 106.

The series of ridges 106 and the soft, cushioned shapes 116 can be, in one embodiment, a plurality of diagonal rows projecting from, or on the top of, the platform 104. More specifically, each ridge within the series of ridges 106 can have a length that is greater than a width, can be solid strips (i.e., they fully extend from one edge of the platform 104 to a second, different edge of the platform 104 and are not diagonal strips that are comprised of several shortened portions) and the series of ridges 106 can be equally spaced and parallel to each other. Further, the ridges 106 can be diagonally angled with respect to the front side and back side of the wall 108. In some embodiments, the series of ridges 106 may comprise an angle that is between 30 to 60 degrees as measured against the front and back walls 108. As illustrated in FIGS. 11-12 and 18-19, some embodiments of the series of ridges 106 may comprise an angle of 45 degrees with respect to the front side and back side of the wall 108. Additionally, the series of ridges 106 may have a distance between each of the ridges 106 that is less than the width of each ridge 106 and, in some cases, less than half of the width of each ridge 106. However, the series of ridges 106 and cushioned shapes 116 may take any shape such as, but not limited to, discs, linear rows, or any other pattern or combination of patterns as illustrated in FIGS. 1, 2, and 18. Additionally, as described above, the platform 104 may be raised, flat, or concave, determined primarily by the shape of the kennel floor, which the kennel mat accommodates. The series of ridges 106 can be comprised of an elastomeric compound, for example, a thermoplastic elastomer, and, as mentioned above, may be formed from a single thermoformed part with other components of the kennel mat. In some embodiments, a bottom of the kennel mat can have indentations that correspond to the series of ridges, as illustrated in FIGS. 12, 17, and 19.

The semi-rigid base/floor 102, while rigid enough to hold its form, preferably has some elasticity and/or flexibility to it and can be made of any elastomeric material. For example, it can be made of or formed from silicone or a TPE. In one embodiment, the semi-rigid base/floor 102 can be made of sheets of a TPE that are thermoformed and sized specifically to predetermined specifications. Additionally, the semi-rigid base/floor 102 can be extremely durable and resistant to chewing, scratching, odors, water or other liquid, fading, and cracking while simultaneously maintaining its elastic characteristics.

In some embodiments, the semi-rigid base/floor 102 can be approximately rectangular in shape and have a flat bottom. The top, or a central portion of the top, of the semi-rigid base/floor 102 may be the platform 104 to which the cushioned shapes 116 can attach and, therefore, the platform 104 can have a corresponding series of ridges 106 built into it. More specifically, the corresponding series of ridges 106 on the top of the platform 104 may be thermoformed into the semi-rigid base/floor 102 to enable more efficient construction of the kennel mat. Therefore, the semi-rigid base/floor 102, platform 104, series of ridges 106, and wall 108 may all be one thermoformed, or other constructed, part. As with the series of ridges 106, the floor can be comprised of an elastomeric compound, such as a thermoplastic elastomer, and a bottom of the kennel mat can have a shape and configuration that corresponds to the top of the floor 102, as illustrated in FIGS. 12, 17, and 19.

The platform 104 can be preferably made of a water-resistant, flexible material. In some embodiments, the platform 104 can be made of the same material as the semi-rigid base/floor 102. For example, the platform 104 can be made of silicone or a TPE. As mentioned above and illustrated in FIGS. 1-6, 9, 11-12, and 17-19, the platform 104 can be formed from the same mold or starting material as the semi-rigid base/floor 102 and can have the series of ridges 106 formed on its top. However, in some embodiments, the platform can be relatively flat and may not have a series of ridges 106. The platform can be raised above the floor 102 and can define the interior circumference of the gutter 114.

The series of ridges 106, as mentioned above, can be strips of similar or varying sizes (such as lengths, widths, or depths) that, when combined on the platform 104, create a repeating, diagonal pattern. Alternatively, the strips, when combined on the platform 104, can create straight rows, such as a repeating horizontal pattern or a vertical striped pattern. In another embodiment, the series of ridges 106 can be discs of similar or varying sizes (such as lengths, widths, or depths) that, when combined on the platform 104, create a repetitive or random pattern. Other shapes, or combinations of the disclosed or other shapes, are envisioned and can be located on the platform 104.

In some embodiments, cushioned shapes 116, 118 can attach to the series of ridges 106 on the platform 104 and to the protruding sections 110 on the walls 108. These cushioned shapes 116, 118 can be comprised of a single layer of closed cell foam (i.e., they are not comprised of multiple layers of a compound or substance added together). More specifically, they can be made of sheets of closed cell foam, such as neoprene or ethylene-vinyl acetate (EVA), and can be shaped (such as via die-cutting) to match the designed series of ridges 106 that are on the platform 104. They may have a thickness equal to or greater than 1/10 the thickness of the series of ridges 106 (for example, they may be ⅕ or ¼ the thickness of the ridges 106). Additionally, they can be patterned or can have a patterned material attached to their surface. The series of ridges 106 and the cushioned shapes 116 may be comprised of matching shapes such as, but not limited to, a plurality of discs, linear rows, diagonal rows, or other shapes or combinations of shapes, as described above. The protruding sections 110 and the cushioned shapes 118 may also be comprised of matching shapes. In one embodiment, the cushioned shapes 116, 118 may be removable from the series of ridges 106 on the platform 104 and on the protruding sections 110 to enable a user to replace one or more cushioned shapes 116, 118, which is beneficial if the cushioned shapes 116, 118 need to be cleaned and/or replaced.

In a preferred embodiment, the series of ridges 106 and protruding sections 110, having cushioned shapes 116, 118 attached to them that can be made of foam, create a comfortable, padded space for an animal to rest on. Additionally, the cushioned shapes 116, 118 can further elevate the animal off of the semi-rigid base/floor 102 and the platform 104 and keep the animal separated from the walls 108. This configuration allows liquid and other debris to pass through the spaces between the cushioned shapes 116, 118. Therefore, the series of ridges 106 and protruding sections 110 can enable air to flow beneath and around an animal for quick drying, and it can help keep the animal cool. To prevent liquid from collecting below the kennel mat, the plurality of eaves 120 may be configured to match the shape of the internal surface of the walls of a kennel, thereby preventing gaps between the kennel mat and the kennel from occurring. In embodiments where the platform 104 is a separate piece from the semi-rigid base/floor 102, the platform 104 can also be durable and resistant to water or other liquid, odor, scratching, chewing, cracking, and fading.

In some embodiments, the series of ridges 106 and protruding sections 110 can have raised lips (not illustrated), which the cushioned shapes 116, 118 can nest within, which helps prevent the cushioned shapes 116, 118 from being easily chewed on or ripped off. The raised lips can have a comparable or shorter height than the cushioned shapes 116, 118 and can be an extension upward of the series of ridges 106 and protruding sections 110. Additionally, the raised lips can be made of the same material as the series of ridges 106 and protruding sections 110.

As described above, the kennel mat can be rectangular and, therefore, may have four walls 108. However, the kennel mat can take any shape and can have a correspondingly appropriate number of walls 108. In some embodiments, the platform 104 can be congruent to the walls 108. For example, the platform 104 and the walls 108 may both form the same shape (i.e., a rectangle). The walls can each have a top, bottom, inner surface, and outer surface, and the bottom of the walls can connect to the floor of the kennel mat. Therefore, the walls can encircle the floor and define the outer circumference of the interior portion of the kennel mat. The outer surface of the walls 108 may be smooth and uniform. Alternatively, as illustrated in FIGS. 12-13, 15-16, and 19, the outer surface of the walls 108 may have indentations that correspond to the plurality of protruding sections 110.

The walls 108 can have a uniform thickness and can protrude up and out from the semi-rigid base/floor 102 at a variety of angles. For example, the walls 108 may be 90-degree vertical walls, or they may be slanted outward at angles greater than 90 degrees. In some embodiments, as illustrated in FIGS. 1-6, 11-12, and 18-19, the corners of the walls 108 may be rounded to prevent injury to an animal or a person responsible for putting the animal in a kennel. The corners may also include eaves 120. These corners may be traditional 90-degree corners, or they may be rounded to prevent injury, as illustrated in FIGS. 18-19. The walls 108 can be made of any rigid or semi-rigid material. For example, they can be made of the same material as the semi-rigid base/floor 102 (such as any elastomeric material, for example, a TPE) and can also have durable and water-resistant properties. Therefore, the walls 108, similar to the platform 104 and series of ridges 106, may be formed or constructed out of the same piece of material as the semi-rigid base/floor 102. However, the walls 108 may be separate pieces.

In some embodiments, all of the walls 108 are uniform in height. However, in other embodiments, one or more of the walls 108 have different heights. For example, the kennel mat, if rectangular in shape, can have two long side walls and a back wall that are uniform in height, as illustrated in FIGS. 7, 10, 13, and 15-16, and a front wall that can be variable in height or can have a substantial portion missing. More specifically, as illustrated in FIGS. 8 and 14, the front wall may have an arched cutout so that, near the corners, the front wall may be the same height as the other walls, but it arcs downward, creating an arched opening with the center of the front wall being the lowest point of the front wall. The eaves 120 may remain at the corners of the arched cutout to enable gap prevention for these particular embodiments. This shape enables an animal to move easily onto and off of the kennel mat. In another embodiment, both the front and the back wall have this arched cutout. Other modifications may be made to the walls 108 that may impact their uniformity. For example, the back side wall may further include a scalloped area within one or more of the protruding sections 110. These scalloped areas may indent inward towards the inner surface of the wall and the platform 104, and they may be disposed on the area that is at the top of the back side wall.

As illustrated in FIGS. 1-2, 9, and 7-19, the protruding sections 110 can be on the inside of the walls 108 and can protrude from the walls 108 toward the interior space of the kennel mat that the animal will occupy. However, in some embodiments, the protruding sections 110 are essentially part of the walls 108 such that the outer surface of each wall 108 corresponds to the plurality of protruding sections 110 on the inner surface of each wall 108. The sections 110 can be similar to the series of ridges 106 and can be made of the same material as the semi-rigid base/floor 102 and the platform 104. Further, the sections 110 can have cushioned shapes 118 (such as foam) attached to their surfaces, can have durable and water-resistant properties, and can be uniform in thickness or can vary in thickness and size. For example, as illustrated in FIGS. 1, 2, and 18-19, the protruding sections 110 may be thinnest at their top ends near the top of the wall 108, may generally slope down toward the interior space of the kennel mat, may thicken as the protruding section slopes downward toward the interior space of the kennel mat, and may end at a relatively flat bottom end that faces the platform 104, series of ridges 106 of the platform, and cushioned shapes 116 of the series of ridges 106. More specifically, as illustrated in FIG. 9, the bottom surface of each section 110 may have a steeper slope than the top surface of each section 110, thereby creating a sloped section 110 having space between its top surface and bottom surface. Additionally, while the top end of the sloped section 110 can be narrow and/or pointed, the bottom end of the sloped section 110 can have a flat face that connects on a first edge to the top surface of a section 110 and on a second edge to the bottom surface of a section 110, as illustrated in FIGS. 1, 2, and 18-19. This flat face makes for a more comfortable surface for an animal to lie against.

The protruding sections 110 may be located on every wall 108, may be on some but not all of the walls 108, or may be located on only one wall 108. Additionally, the protruding sections 110 can cover a portion of or all of each wall 108. While the protruding sections 110 can be a similar height to the walls 108 (and can be the same or similar height when taking into account the attached, cushioned shapes 118), the protruding sections 110 may have any height and/or any length. This enables a section 110 to cover the entire length and/or height of a wall 108 or a portion of the length and/or height of the wall 108.

In some embodiments, each of the protruding sections 110 on the right and left side walls 108 can have a width that is at least twice the distance of the space between each protruding section 110. Further, the protruding sections 110 on the back wall 108 can be the same width as the protruding sections 110 on the right and left side walls 108.

As illustrated in FIG. 11, the back wall protruding sections 110 can be centered as a group on the back side. For example, in cases where there are two protruding sections 110 on the back wall 108, one can be located on either side of the center line such that they mirror each other. In some embodiments, at least some of the back wall protruding sections 110 do not extend past the planes defined by the side and back lines of the platform 104. Therefore, the back wall protruding sections 110 may be absent from the corners of the kennel mat.

In some embodiments, the backmost protruding section 110 on the right side wall 108 of the kennel mat may be spaced away from the back wall 108, and the backmost protruding section 110 on the left side wall 108 of the kennel mat may be spaced away from the back side. Further, the outermost protruding sections 110 on the back side wall 108 may be spaced away from the right and left side walls 108 of the kennel mat such that all protruding sections 110 may be absent from at least the corners of the kennel mat.

In one embodiment, the kennel mat can be rectangular, have four protruding sections 110 on each of its two long walls, two protruding sections 110 on its back wall, and, due to the missing portion (ex: arched cutout) of the front wall, no protruding section 110 on its front wall. Alternatively, both short walls (such as the front wall and the back wall) may have two protruding sections 110. In some embodiments, all of the protruding sections 110 are uniform in size. In other embodiments, the protruding sections may vary in size. For example, the front wall may have smaller, protruding sections 110 than the protruding sections 110 on the other walls, with one of each of the smaller protruding sections 110 on either side of the arched cutout. However, if the front wall does not have an arched cutout, the kennel mat may have two protruding sections 110 on its front wall that are similar in size to the protruding sections 110 on the back wall.

In embodiments wherein a wall 108 includes a plurality of protruding sections 110, there can be spaces or gaps 112 in between each of the protruding sections 110. For protruding sections 110 on a first wall that end near a second wall having no protruding sections 110, there can be a space or gap 112 between the second wall and the final protruding section 110 on the first wall in addition to the spaces or gaps 112 between all of the protruding sections 110. These spaces or gaps 112 can collect liquid and debris that falls off of the animal while the animal is on the mat due to the space created between the animal and the walls 108 by the protruding sections 110. To prevent liquid from collecting below the kennel mat, the plurality of eaves 120 may be configured to match the shape of the internal surface of the walls of a kennel, thereby preventing gaps between the kennel mat and the kennel from occurring.

In addition to the spaces or gaps 112, in some embodiments, the kennel mat, as described above, has gutters 114 that also collect liquid and debris. The gutters 114 can be located between the outer circumference of the platform 104 and the flat face of the bottom end of the protruding sections 110. In some embodiments, the spaces or gaps 112 are branches that connect to the main channel of the gutters 114 so that any liquid or debris that falls into the spaces or gaps 112 can transfer into the gutters 114, or vice versa. In one embodiment, the spaces between the series of ridges 106 and/or cushioned shapes 116 can be raised slightly higher than the spaces or gaps 112 and gutters 114, as illustrated in FIGS. 9 and 17. However, because the spaces between the series of ridges 106 and/or cushioned shapes 116 extend to the edge of the platform 104, any liquid or debris that falls into those spaces can transfer into the spaces or gaps 112 and the gutters 114.

In some embodiments, the kennel mat can be one removable piece that can be placed into and taken out of a kennel. In other embodiments, two or more of the individual components of the kennel mat are removable from each other to make for easier cleaning and/or replacement of parts. For example, the platform 104 may be separable from the semi-rigid base/floor 102, the series of ridges 106 may be separable from the platform 104, the cushioned shapes 116, 118 may be separable from the series of ridges 106 and/or protruding sections 110, the walls 108 may be removable, the protruding wall sections 110 may be removable, or any of the above in combination may be possible.

In embodiments where the platform 104 is separable from the semi-rigid base/floor 102, various ways of attaching the platform 104 to the semi-rigid base/floor 102 may exist. For example, the platform 104 may rest on top of the semi-rigid base/floor 102, the series of ridges 106 may align on the platform 104 with corresponding shapes on the top of the semi-rigid base/floor 102, or the platform 104 and series of ridges 106 may be one piece that can attach to the semi-rigid base/floor 102 along its edges. In the example of the platform 104 and series of ridges 106 attaching to the semi-rigid base/floor 102 along its edges, the attachment may take place through, for example, the use of hook and loop fasteners, snaps, buttons, slots, and corresponding protrusions, or a rails system.

In embodiments where the walls 108 are removable, the walls 108 may attach to the semi-rigid base/floor 102 and each other through the use of, for example, hook and loop fasteners, snaps, buttons, slots, and corresponding protrusions, or a rail system. In embodiments where the protruding sections 110 on the walls 108 are removable, the protruding sections 110 may attach to the walls 108 through the use of, for example, hook and loop fasteners, adhesive, snaps, slots, and corresponding protrusions, or a rail system. When walls 108 are removable, this may allow the placement of the remaining central portions of the kennel mat into a different kennel with differently sized walls 108 that are configured for that kennel.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A kennel mat comprising:
a wall having a top, a bottom, an inner surface, and an outer surface, wherein the bottom of the wall connects to a floor of the kennel mat, wherein the wall encircles the floor, and further wherein the wall and floor are comprised of a single piece of a semi-rigid material;
a plurality of eaves projecting from the top of the wall away from the inner surface of the wall, wherein the plurality of eaves are configured to be received by an interior structure of a kennel in such a manner to prevent gaps between the plurality of eaves and the interior structure of the kennel;
a plurality of protruding sections protruding in from the inner surface of the wall, wherein the plurality of protruding sections convexly slope beginning from the top of the wall where they are nearly parallel to the wall and ending further down the wall where a top surface of each protruding section is nearly parallel to the floor, wherein the slope is a single radius, wherein once a top surface of each protruding section is nearly parallel to the floor a side surface of each protruding section becomes perpendicular to the floor to form a junction to the floor, and wherein the junction defines a perimeter of a lower surface of the floor;
a platform raised above the floor, wherein the platform defines a gutter between the wall and the platform, and wherein the lower surface of the floor, defined by the gutter, supports the kennel mat within the kennel; and
a series of ridges projecting from the raised platform, wherein the series of ridges are equally spaced and parallel to each other.

2. The kennel mat of claim 1, wherein the series of ridges comprises a layer of cushioned shapes disposed on each upper surface of the series of ridges and the plurality of protruding sections.

3. The kennel mat of claim 1, wherein the wall is further comprised of a front side, a back side, a left side, and a right side, and wherein the front side has no protruding sections.

4. The kennel mat of claim 3, wherein each of the plurality of protruding sections on the right side and left side comprise a width that is at least twice the distance of a gap between each protruding sections.

5. The kennel mat of claim 4, wherein the plurality of protruding sections on the back side are the same width as the plurality of protruding sections on the right side and left side, and wherein the plurality of back side protruding sections are centered as a group on the back side and do not extend into the side planes defined by the platform.

6. The kennel mat of claim 5, wherein a backmost protruding section on the right side is spaced away from the back side, wherein a backmost protruding section on the left side is spaced away from the back side, and wherein each outermost protruding sections on the back side is spaced away from the left and ride sides, respectively.

7. The kennel mat of claim 5, wherein the plurality of protruding sections are comprised of at least four protruding sections on the right side, at least four protruding sections on the left side, and at least two protruding sections on the back.

8. The kennel mat of claim 3, wherein the plurality of eaves are located on the back side, the left side, and the right side.

9. The kennel mat of claim 8, wherein the back side further includes a scalloped area within a protruding section, and wherein the scalloped area indents towards the inner surface of the wall and is disposed in the area that is at the top of the wall.

10. The kennel mat of claim 3, wherein the wall, the plurality of eaves, the plurality of protruding sections, the platform, and the series of ridges include an elastomeric compound.

11. The kennel mat of claim 10, wherein the elastomeric compound is a thermoplastic elastomer.

12. The kennel mat of claim 10, wherein the wall, the plurality of eaves, the plurality of protruding sections, the platform, and the series of ridges are formed from a single thermoformed part.

13. The kennel mat of claim 12, wherein the outer surface of the wall has indentations that correspond to the plurality of protruding sections.

14. The kennel mat of claim 12, wherein a bottom of the kennel mat has indentations that correspond to the platform and the series of ridges.

15. The kennel mat of claim 1, wherein the platform is congruent to the wall.

16. The kennel mat of claim 1, wherein each ridge within the series of ridges has a length that is greater than a width, and wherein the ridges are diagonally angled with respect to the front side and back side of the wall.

17. The kennel mat of claim 16, wherein the ridges are angled between 30 degrees and sixty degrees with respect to the front side and back side of the wall.

18. The kennel mat of claim 17, wherein the series of ridges are angled at forty-five degrees with respect to the front side and back side of the wall.

19. The kennel mat of claim 18, wherein the series of ridges are spaced from each other at a distance that is less than the width of each ridge of the series of ridges.
